(19) United States
(12) Patent Application Publication
(10) Pub. No.: US 2016/0010829 A1
(43) Pub. Date: Jan. 14, 2016

(54) LOW-PROFILE OPTICAL ARRANGEMENT

(71) Applicant: KONINKLIJKE PHILIPS N.V., Eindhoven (NL)

(72) Inventors: Vincent Stefan David GIELEN, Eindhoven (NL); Sait IZMIT, Utrecht (NL); Ferry ZIJP, Nuenen (NL); Oliver DROSS, Waalre (NL); Peter Adrianus Albert KEMPS, Schijndel (NL); Olena IVANOVA, Eindhoven (NL)

(21) Appl. No.: 14/772,845

(22) PCT Filed: Mar. 6, 2014
(86) PCT No.: PCT/IB2014/059488

§ 371 Date: Sep. 4, 2015

Related U.S. Application Data
(60) Provisional application No. 61/773,858, filed on Mar. 7, 2013.

(51) Int. Cl. F21V 13/04; F21V 5/04; F21V 7/04

(52) U.S. Cl. CPC F21V 13/04; F21V 7/04; F21V 5/04; F21V 5/045

(57) ABSTRACT

The present invention relates to an optical arrangement (1) having an optical axis (X) and comprising a base member (70), a cup shaped reflector (10) having an inner surface (12) facing towards the optical axis, at least one solid state light source (40, 42) arranged at the optical axis on the base member, and a lens comprising a center lens portion (20) and an annular lens portion (30), and arranged in front of the at least one solid state light source in a light exit direction. The center lens portion has a dome shaped outer surface (22) and the annular lens portion has an outer surface (32) with a convex shape facing the inner surface of the reflector. The reflector and the lens are formed together as one solid piece of material.

### FIELD OF THE INVENTION

The present invention relates to an optical arrangement, and especially to a low-profile optical arrangement comprising a reflector and a lens.

### BACKGROUND OF THE INVENTION

Parabolic or aspheric axially symmetric reflectors are used for incandescent, discharge and LED light sources and luminaires due to their simplicity and good beam control. To capture a majority of the source light flux, and to provide a high cd/lm (Candela per Lumen) beam, the open reflectors need to be very deep. However, shallow, compact reflectors are desired to allow small external size of the light source or luminaire, and to give more space to driver electronics and cooling fins as required in LED light sources, e.g. MR16, GU10 and AR111 luminaires. Further, in open reflectors the light source is visible and exposed, which is undesirable and even dangerous, and a significant amount of light escapes the luminaire without being collimated and not reaching the reflector, which causes glare and a wide background of light.

EP2211094A1 presents a luminaire structure for collimation of light from a light source into a narrow beam. However, such arrangement is still rather deep and comprises a large number of components which increases the costs for manufacturing and assembling, and also makes the assembling complex and sensitive to tolerances.

Another light-emitting unit adapted to provide for a somewhat more compact structure is presented in US2011/0140145A1. In such unit, light from a light source is refracted into a lens unit. Inside the lens unit, an amount of the light undergoes a total internal reflection (TIR) at an outer surface of the lens unit. A second refraction of the light occurs when the light leaves the lens unit. The purpose is to collimate light to provide a focused beam. However, such lens unit is still very thick and tall. It thereby becomes expensive to produce for light-emitting units of larger diameters.

Consequently, it would be desired with a luminaire that provides a compact arrangement with good beam control and which is reliable and easy to assemble.

### SUMMARY OF THE INVENTION

It is an object of the present invention to overcome this problem, and to provide a low-profile optical arrangement which collimates the light in a desired way. According to a first aspect of the invention, this and other objects are achieved by an optical arrangement having an optical axis and comprising a base member, a cup shaped reflector having an inner surface facing towards the optical axis, at least one solid state light source arranged at or close to the optical axis on the base member, a lens comprising a center lens portion and an annular lens portion, and arranged in front of the at least one solid state light source in a light exit direction. The center lens portion has a dome shaped outer surface, the annular lens portion has an outer surface with a convex shape facing the inner surface of the reflector. The reflector and the lens may be formed together as one solid piece of material.

The lens may be adapted to cooperate with the cup shaped reflector in order to direct light out of the optical arrangement. The light from the light source in the present optical arrangement which reaches the center lens portion may be substantially collimated by the center lens portion to the optical axis. Two refractions may occur when the light from the light source enters and leaves the center lens portion, and may thereby be directed to be collimated with the optical axis. The annular lens portion may be arranged as a circular section around the center lens portion. The center lens portion may have a dome shape, and the annular lens portion may have a convex shape which may be seen as an irregular continuation of the dome shape of the center lens portion. The convex shape may be an aspheric or spherical shape. It may be a generalized Cartesian oval shape. The convex outer surface of the annular lens portion may be directed towards the inner surface of the reflector. Light from the light source which reaches the annular lens portion may be directed towards the inner surface of the reflector. Two refractions may occur when the light from the light source enters and leaves the annular lens portion, and may thereby be directed towards the reflector. The light may then be reflected on the inner surface of the e.g. parabolic reflector.

The lens and the reflector may be formed as one solid piece of material. The material in the solid piece of reflector and lens may be a dielectric material, such as a glass or plastic material. By forming the two parts as one piece, an easy assembly of the arrangement is provided. Further, it may improve both optical and thermal properties of the arrangement. With the optical arrangement in a light emitting device, the integrated lens and reflector may be a part of a housing of the light emitting device, forming an external surface of the light emitting device.

The cup shaped reflector may provide a profile, flat or curved, either spherical or aspheric, which provides a cup shape. The reflector may be a parabolic reflector. The reflector may be provided with facets or similar to improve the homogenization of the light output from the optical arrangement. Similarly, the lens portion may, on its inner and/or outer side, be provided with facets, micro lenses or similar to improve the function of the arrangement. The convex shape of the outer surface of the annular lens portion provides that light reaching the annular lens portion may be directed to reach the inner surface of the reflector even with a compact arranged reflector. Hence, the reflector may be shallower than with a lens without any convex portion. By directing the light from the light source using the present lens portions and reflector, the light may be collimated with the optical axis in an amount of providing a highly focused beam from the optical arrangement. Further, by providing the reflector and the lens as one solid piece of material, an arrangement of lower cost may be provided, as well as an easier assembly of the arrangement.

In one embodiment, the center lens portion and the annular lens portion each may have an inner surface together forming an inner cavity in which inner cavity the at least one solid state light source may be arranged. The different inner surfaces forming the inner cavity may provide the direction of light from the light source to the center lens portion or the annular lens portion. The location of each inner surface may correspond to the amount and direction of light which may be directed to either lens portion.

The inner surface of the center lens portion may extend substantially perpendicular to the optical axis. The inner surface of the center lens portion extending substantially perpendicular to the optical axis may provide a refraction of the light from the light source that together with the dome shaped outer surface of the center lens portion may provide a desired collimation of the outgoing light. Alternatively, the inner surface of the center lens portion may have a convex, concave or aspheric shape. The inner surface may thereby further be adapted for cooperating with the outer surface of the center lens portion to collimate the light from the at least one light source. The inner surface may, regardless of its shape, be provided with micro lenses to control a light mixing of the light from the at least one light source.

Further, a first portion of the inner surface of the annular lens portion may extend substantially in parallel with the optical axis. The inner surface of the annular lens portion extending substantially in parallel with the optical axis may provide a refraction of the light from the light source that together with the aspheric shaped outer surface of the annular lens portion may provide a desired direction of the outgoing light towards the parabolic reflector.

The inner surface of the annular lens portion may further comprise a second portion proving a curved shape from the first section of said inner surface to a third section of said inner surface extending substantially perpendicular to the optical axis and facing the base member. The curved shape of the second portion of the inner surface may be of a Cartesian oval shape. The curved shape between the first portion in parallel with the optical axis and the third portion facing the base member may assure that light from the light source extending close to the base member may reach the reflector. The curved shape may provide a refraction of the light that is sufficient to direct the light, together with a second refraction at the outer surface of the annular lens portion, towards the reflector. If the inner surface did not have such curved shape, a larger amount of light may have failed to reach the reflector and thereby not been collimated with the optical axis.

In another embodiment, the inner surface of the reflector may be coated with a reflective coating. To improve the optical reflection of the light reaching the reflector to be collimated with the optical axis, the inner surface of the reflector may be provided with a reflective coating. Such coating may be a metallic coating. Alternatively, an outer surface of the reflector may be provided with grooves for total internal reflection. The outer surface may be located on an opposite side of the reflector relative to the inner surface. The total internal reflection grooves may provide two total internal reflections of the light to provide the reflection in the reflector and the collimation of the light.

In one embodiment, the reflector forms a space into which the lens protrudes, and wherein the light directed by the annular lens portion is adapted to pass through said space towards the reflector. The light from the light source may undergo two refractions when passing through the annular lens portion. After having been directed by these refractions, the light may pass through said space towards the reflector and thereby being reflected on the inner surface of the reflector.

In a further embodiment, the annular lens portion may comprise an outer surface facing towards the reflector with a first convex shape and a second convex shape different from the first convex shape. Light reaching different parts of the reflector may be directed and collimated differently. It is important that light leaving different portions of the annular lens portion are directed correctly towards the reflector. By providing different convex shapes in different portions of the outer surface of the annular lens portion, a larger amount of light may be directed towards the reflector in order to avoid that light leaving the annular lens portion escapes from the optical arrangement without reaching the reflector. The first convex shape of the outer surface of the annular lens portion may have a smaller radius than the second convex shape, and the first convex shape of the outer surface may be arranged adjacent the center lens portion and the second convex shape of the outer surface is arranged remote the center lens portion. The first and second convex shapes may be spherical or aspheric shapes. The first and second convex shapes may be generalized Cartesian oval shapes.

According to a second aspect of the invention, a light emitting device is provided which comprises an optical arrangement as presented above. The light emitting device may further comprise a housing and a heatsink.

It is noted that the invention relates to all possible combinations of features recited in the claims.

### BRIEF DESCRIPTION OF THE DRAWINGS

Various aspects of the invention, including its particular features and advantages, will be readily understood from the following detailed description and the accompanying drawings, in which:

FIG. 1 is a perspective view of a luminaire comprising an optical arrangement according to an embodiment of the invention;

FIG. 2 is a cross-sectional view of an optical arrangement according to an embodiment of the invention;

FIG. 3 is a cross-sectional view of a light emitting device comprising an optical arrangement according to an embodiment of the invention; and

FIG. 4 is a cross-sectional view of a light emitting device comprising an optical arrangement according to an embodiment of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person. Like reference characters refer to like elements throughout.

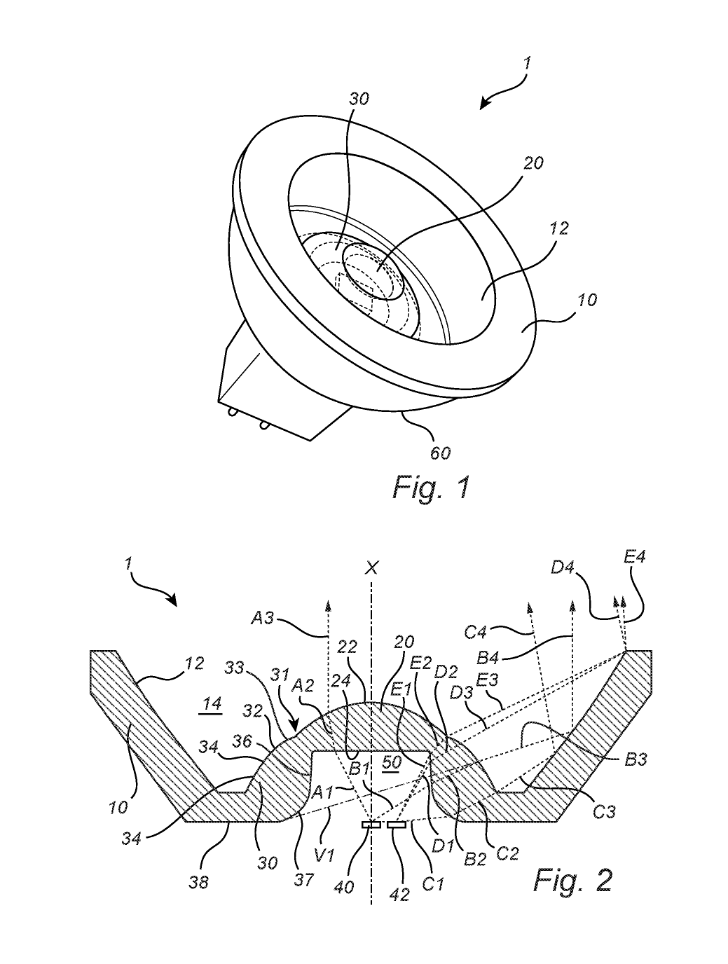

FIG. 1 illustrates a light emitting device comprising an optical arrangement 1. In the illustrated embodiment, the optical arrangement 1 comprises a parabolic reflector 10 having an inner surface 12 and a lens having a central lens portion 20 and an annular lens portion 30. The described functions of the optical arrangement will however be applicable on other cup shaped reflectors.

FIG. 2 illustrates in a cross-sectional view the optical arrangement 1 with an optical axis X and comprising a parabolic reflector 10 and a lens. The lens comprises a central lens portion 20 and an annular lens portion 30. The lens is arranged in front of light sources 40, 42. The parabolic reflector 10 has an inner surface 12 facing towards the optical axis X. The parabolic reflector forms a cup shaped space 14. The lens 20, 30 protrudes into said space 14.

The central lens portion 20 has a dome shaped outer surface 22 and an inner surface 24 facing towards the light source 40. The inner surface 24 extends in a plane perpendicular to the optical axis X. The annular lens portion 30 has an aspheric shaped outer surface 32 and an inner surface 36, 37, 38 facing towards the light sources 40, 42. The inner surfaces 24, 36, 37, 38 of the lens portions 20, 30 together form an inner cavity 50 in which the light source 40 is arranged.

The parabolic reflector 10 and the lens 20, 30 are formed as one solid piece.

Light A1 from the light source 40 that reaches the central lens portion 20 is refracted at the interface between the inner cavity 50 and the central lens portion 20. The light A2 extending through the central lens portion 20 is further refracted at an interface between the central portion 20 and ambient air (or the space 14). The flat extension of the inner surface 24 and the dome shape of the outer surface 24 of the central lens portion 20 provides the light A3 leaving the central lens portion 20 is collimated. The light A3 may be substantially in parallel with the optical axis X.

The inner surface of the annular lens portion 30 has a first portion 36 extending substantially in parallel with the optical axis X, or with an angle less than 10 degrees to the optical axis X. The first section 36 is arranged adjacent the inner surface 24 of the central lens portion 20. The inner surface of the annular lens portion 30 further has a second portion 37 and a third portion 38. The second portion 37 extends in a curved shape in the form of a Cartesian oval shape. The third portion 38 faces a base member 70 and extends in a plane perpendicular to the optical axis X. The curve shaped second portion 37 extends between the first and the third portion.

Light B1 from the light source 40 that reaches the first portion 36 of the inner surface of the annular lens portion 30 is refracted. It further extends as light B2 in the annular lens portion 30 and exits the annular lens portion 30 at the outer surface 32 thereof to light B3. The light B3 travels through the space 14 in a direction that coincides with a virtual ray V1 which extends in a straight line from a point of interface between the second portion 37 and third portion 38 of the inner surface of the annular lens portion 30 towards the inner surface 12 of the parabolic reflector. The light B3 is reflected on the inner surface 12 of the parabolic reflector 10 to collimated light B4.

The curve shaped second portion 37 of the inner surface of the annular lens portion 30 has a purpose of refracting light C1 from the light source 40 that extends with small angles to the plane of the third portion 38. The shape of the second portion 37 provides refraction such that light C2 extends through the annular lens portion 30 in a direction sufficient to be refracted at the outer surface 32 of the annular lens portion 30. The light C3 leaving the annular lens portion extends through the space 14 and is reflected on the inner surface 12 of the parabolic reflector 10 to collimated light C4. Such arrangement provides that light extending from the light source 40 in a direction perpendicular or close to perpendicular to the optical axis still is collimated from the arrangement 1.

In one embodiment, the aspheric shaped outer surface 32 of the annular lens portion 30 comprises a first aspheric shape 33 and a second aspheric shape 34. The first aspheric shape 33 has a smaller radius than the second aspheric shape 34. The first aspheric shape 33 is arranged adjacent to the outer surface 22 of the center lens portion 20. An interface 31 is formed between the outer surface 22 of the center lens portion 20 and the first aspheric shape 33 of the outer surface 32 of the annular lens portion 30. The first and second aspheric shapes 33, 34 have Cartesian oval shapes.

A light source 42 may be provided that is not arranged at the optical axis X in the inner cavity 50. The first aspheric shape 33 is provided to make sure light D1, E1 from such light source 42 that reaches the first portion 36 of the inner side of the annular lens portion 30, close to the inner side 24 of the center lens portion 20, does not escape out of the arrangement 1 without being collimated. The light D1, E1 is refracted into the annular lens portion 30. The light D2, E2 is further refracted at the first aspheric shape 33 of the outer surface 32 to be directed as light D3, E3 towards the parabolic reflector 10. The light D3, E3 is then reflected on the inner surface 12 of the parabolic reflector 10 into collimated light D4, E4. Due to the outer surface 32 of the annular lens portion 30 comprising the first and the second aspheric shapes 33, 34 a larger amount of light from the light sources 40, 42 is collimated. All light B3, C3, D3, E3 that leaves the outer surface 32 of the annular lens portion 30 is collimated by the parabolic reflector 10.

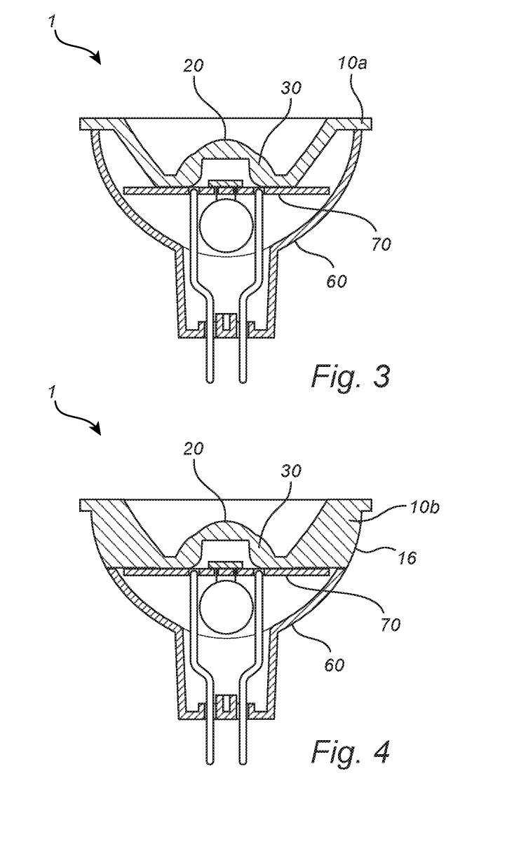

FIG. 3 illustrates an embodiment of a light emitting device comprising an optical arrangement 1 according to the invention. The light emitting device comprises a base 70 onto which the optical arrangement 1 and light sources 40, 42 are arranged, and a housing 60. The housing 60 and the optical arrangement 1 form the externals of the light emitting device. The parabolic reflector 10a is arranged in contact with the housing 60.

FIG. 4 illustrates an embodiment of the optical arrangement 1 arranged in a light emitting device. The parabolic reflector 10b is provided with thick reflector walls. The reflector 10b may form part of the housing 60. Such reflector 10b may provide for heat transfer function for the light emitting device. The base 70 onto which the optical arrangement 1 is arranged may transfer heat from the light sources 40, 42. The parabolic reflector 10a may improve the heat transfer performance from the base 70. The base may be a printed circuit board. The parabolic reflector 10b with thick walls combines functions of optical performance, housing, heat sinking and electrical protection. An outer surface 16 of the parabolic reflector 10b forms, together with the housing 60, an outer surface of the optical arrangement 1.

The person skilled in the art realizes that the present invention by no means is limited to the preferred embodiments described above. On the contrary, many modifications and variations are possible within the scope of the appended claims. For example, the outer surface of the annular lens portion may have any convex shapes, such as spherical or aspheric shapes, the inner surface of the center lens portion may have a flat shape or any curved shape such as spherical, aspheric or any convex or concave shape, and the reflector may have any flat or curved cup shape, such as a spherical or aspheric shape. Further, the sizes of the aspheric shapes and the shape of the inner cavity may differ.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

1. An optical arrangement having an optical axis and comprising
a base member,
a cup shaped reflector having an inner surface facing towards the optical axis,
at least one solid state light source arranged at or close the optical axis on the base member,
a lens comprising a center lens portion and an annular lens portion, and arranged in front of the at least one solid state light source in a light exit direction,
wherein the center lens portion has a dome shaped outer surface,
wherein the annular lens portion has an outer surface with a convex shape facing the inner surface of the reflector.

2. The optical arrangement according to claim 1, wherein the reflector and the lens are formed together as one solid piece of material.

3. The optical arrangement according to claim 1, wherein the center lens portion and the annular lens portion each has an inner surface together forming an inner cavity in which inner cavity the at least one solid state light source is arranged.

4. The optical arrangement according to claim 1, wherein the inner surface of the center lens portion extends substantially perpendicular to the optical axis.

5. The optical arrangement according to claim 3, wherein the inner surface of the center lens portion extends in a convex, concave or aspheric shape.

6. The optical arrangement according to claim 3, wherein a first portion of the inner surface of the annular lens portion provides a surface extending substantially in parallel with the optical axis.

7. The optical arrangement according to claim 6, wherein the inner surface of the annular lens portion comprises a second portion proving a curved shape from the first section of said inner surface to a third section of said inner surface extending substantially perpendicular to the optical axis and facing the base member.

8. The optical arrangement according to claim 1, wherein the inner surface of the reflector is coated with a reflective coating.

9. The optical arrangement according to claim 1, wherein an outer surface of the reflector is provided with grooves for total internal reflection.

10. The optical arrangement according to claim 1, wherein the reflector forms a space into which the lens protrudes, and wherein the light directed by the annular lens portion is adapted to pass through said space towards the reflector.

11. The optical arrangement according to claim 1, wherein the convex shaped outer surface of the annular lens portion has a spherical or aspheric shape.

12. The optical arrangement according to claim 1, wherein the annular lens portion comprises an outer surface towards the reflector with a first convex shape and a second convex shape different from the first convex shape.

13. The optical arrangement according to claim 12, wherein the first convex shape of the outer surface of the annular lens portion has a smaller radius than the second convex shape, and wherein the first convex shape of the outer surface is arranged adjacent the center lens portion and the second convex shape of the outer surface is arranged remote the center lens portion.

14. The optical arrangement according to claim 12, wherein the first and second convex shapes are aspheric shapes.

15. A light emitting device comprising an optical arrangement according to claim 1.
